(19) United States
(12) Patent Application Publication
(10) Pub. No.: US 2019/0256011 A1
(43) Pub. Date: Aug. 22, 2019

(54) CONTROL PANEL FOR AN OPERATING MACHINE

(71) Applicant: MAGNI TELESCOPIC HANDLERS S.R.L., Castelfranco Emilia (IT)

(72) Inventor: Riccardo MAGNI, Modena (IT)

(21) Appl. No.: 16/343,343

(22) PCT Filed: Oct. 19, 2017
(86) PCT No.: PCT/IB2017/001263

§ 371 Date: Apr. 18, 2019

(30) Foreign Application Priority Data
Oct. 21, 2016 (IT) 10206000106155

(51) Int. Cl. B60R 11/02; B66F 13/00; B66F 11/04

(52) U.S. Cl. CPC B60R 11/0264; B60R 2011/004; B66F 11/044; B66F 13/00

(57) ABSTRACT

The present invention relates to a control panel for an operating machine with a turret that can rotate, on command, about a vertical axis relative to a self-propelled truck provided with wheels which equip the machine. A working arm is articulated to the turret and is adapted to carry a tool at its free end; The control panel or manoeuvring panel is placed on a side of the truck and is so positioned as to be accessible to an operator directly from the ground. The hide-away control panel is constrained to a side of said self-propelled truck on wheels and is rotatable from the hide-away position, parallel to the side surface of the truck on wheels, to at least one horizontal position and vice versa.

The invention relates to a control panel for an operating machine with a rotatable turret.

Specifically, but not exclusively, it is applied to an operating machine such as a self-propelled aerial platform of the type provided with a truck mounted on wheels, to which a turret rotatable around a vertical axis is coupled, with a maneuvering arm articulated thereto and designed to carry the aerial platform or any other tool at its other end.

The type of operating machine in question has a relatively simple structure and dimensions that, in order to allow for transportation of the machine, define a maximum width which does not exceed that of the vehicle on which it is loaded for transport on the road.

Machines according to the prior art are provided with a control panel or maneuvering panel which is located on the rotating turret.

However, this position has some drawbacks, not so much in the operational phase but rather in the positioning of the machine on the platform of the transport vehicle. Indeed, the operator must climb safety-free on the platform in order to gain access to the controls in order to operate.

The main object of the present invention is to overcome the disadvantages of the prior art mentioned above, in particular to propose a control panel or maneuvering panel that is arranged on said truck and is so positioned as to be accessible by an operator directly from the ground.

The above mentioned objects are wholly obtained by means of a control panel for operating machines, as described and claimed farther on in the present description and claims.

The characteristic features of the invention will become more evident in the following description of a preferred, but not the exclusive embodiment illustrated by way of not limiting example with the help of the enclosed figures, in which:

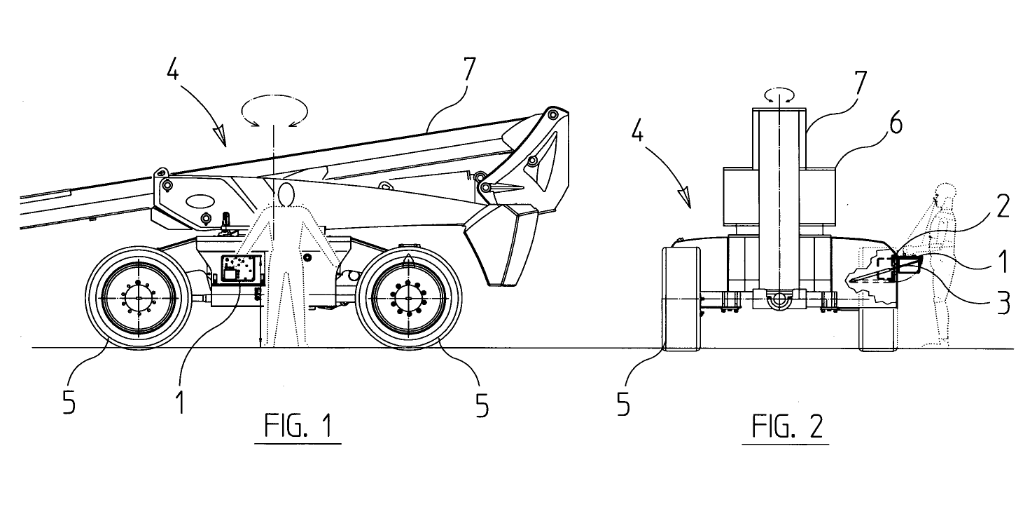

FIG. 1 is a schematic side vertical elevation view;

FIG. 2 shows a schematic view from the left of FIG. 1, in which the control panel is depicted in a different position;

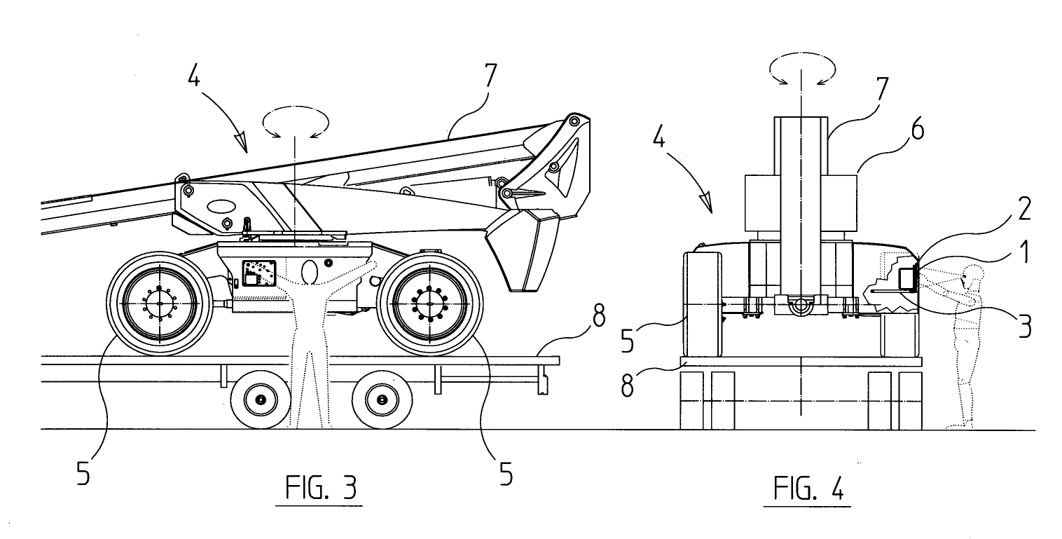

FIG. 3 shows the same schematic side vertical elevation view of FIG. 1 in a different operational configuration;

FIG. 4 shows a schematic view from the left of FIG. 3.

With reference to the above mentioned figures, 1 indicates a control panel or maneuvering panel provided for a self-propelled operating machine 4.

In particular, the operating machine 4 is provided with a turret 6, rotatable on command about a vertical axis relative to a truck mounted on wheels 5. An end of a working arm 7 is articulated to the rotatable turret 6; the arm is designed to carry a tool, such as an aerial platform, which is not shown in the attached figures, at the other end.

The control panel 1 consists of a maneuvering panel that includes all electrical and hydraulic controls provided for operation of the operating machine as well as the necessary various displays together in a single space. The control panel has a particular location as it is arranged on the truck and is so positioned as to be easily accessible by an operator directly from the ground.

It is, in fact, pivoted hide-away fashion or flush to a side of the truck, and it is hinged thereto pivoting about a horizontal or almost horizontal axis by means of hinges 2.

In addition to the pivot-like connection, made possible by the hinges 2, there are provided positioning means able to allow it to be orientated from a hide-away position or flush to the surface of the truck side, to at least one position characterized by horizontal orientation. The latter is arranged to be at a height easily accessible by an operator standing on the ground.

The means able to allow rotation of the control panel 1 about the axis of the hinges 2, according to the needs of the operator, comprise at least one gas spring 3.

The advantages provided by the invention arise from the fact that, due to the height positioning of the control panel and to the fact that it can be tilted in accordance to the operator's needs, the operator can conveniently operate standing on the ground in all conditions in which machine may be, in particular the operation position, with the wheels 5 resting on the ground (FIGS. 1 and 2) and in a position placed on a loading platform of a transport vehicle (8).

This also allows the operator to work in a security condition, as he can operate, for example, simply maneuvering from the ground safely, also during operation as for closing the working arm 7 without having to climb on the platform in order to access the controls in the condition of lack of security handhold.

1). A control panel for an operating machine equipped with a turret rotatable on command about a vertical axis with respect to a self-propelled wheeled truck fitted to the machine; a working arm being articulated to the turret and adapted to accommodate a tool at its free end; characterized in that the control panel is arranged on board of said wheeled truck and is so positioned as to be accessible to an operator from the ground in all position of the operating machine in particular in the working position with the wheels on ground and in the position with the wheels resting on the loading platform of a truck; the control panel is pivoted to the side of said wheeled truck so as to rotate about a horizontal or almost horizontal axis.

2). A control panel according to claim 1, characterized in that the control panel is pivoted to a side of said wheeled truck in a way that it can be hidden.

3). A control panel according to claim 3, characterized by comprising positioning means aimed at allowing orientation thereof from a retractable position, which is parallel to the side surface of the wheeled truck, to which it is pivoted so as to be hidden, to at least one horizontal laying position and vice versa.

4). A control panel according to claim 3, characterized in that said positioning means comprise at least one gas spring.
